(19) United States
(12) Patent Application Publication
(10) Pub. No.: US 2004/0075670 A1
(43) Pub. Date: Apr. 22, 2004

(54) Method and system for receiving interactive dynamic overlays through a data stream and displaying it over a video content

(76) Inventors: Eric Camille Pierre Bezine, Paris (FR); Jeremie Francois Chassaing, Paris (FR); Antoine Julien Jean Buhl, Paris (FR)

Correspondence Address: Davidson Davidson & Kappel, 14th Floor, 485 Seventh Avenue, New York, NY, 10018, US

(21) Appl. No.: 10/343,442

(22) PCT Filed: Jul. 27, 2001
(86) PCT No.: PCT/IB01/01355

(51) Int. Cl. G09G 5/00

(52) U.S. Cl. 345/619

(57) ABSTRACT

A system and method for receiving and displaying computer animations and graphical user interfaces, comprising interactive, animated, semi-transparent graphics and/or combined text or other displayable information. The animations are received from a data storage system or a network through a data stream, and possibly created, modified and destroyed either through the data stream or as a consequence of a user action on the interactive items. In addition, the animations are intended to be semi-transparently displayed over a background video content, either in a single or in a set of digital video file(s) or stream(s).

### FIELD OF THE INVENTION

This invention relates generally to computer GUI (Graphical User Interface) creation and the display of multimedia images and text, and more particularly to a system and method for transferring and displaying multimedia interactive content and GUI over video.

### BACKGROUND OF THE INVENTION

Generally, known techniques permit the creation of graphical interfaces enabling the user of a general-purpose computer (such as an IBM/PC compatible computer) to accomplish many tasks.

But the behavior of such interfaces is fixed because (i) the graphical appearance of the GUI is embedded in the computer program, and (ii) the modalities of interactions between the computer and its user remain unchanged during the run time of the software program. Consequently, it is generally impossible to modify the behavior of a computer program without a disrupting its use by a user.

From a programmer's point of view, the GUI and its behavior must be statically defined by an experienced programmer. As a consequence, any change in the look-and-feel (the computer program GUI) of the program requires an update package, which implies a heavy setup mechanism.

With the growth of computer capabilities, network bandwidth, capacity and speed of mass storages such as CD-ROM (Compact Disc—Read Only Memory) and DVD (Digital Versatile Disc), digital video streams and files have became larger and now tend to fill the entire screen. As a result, GUI controls of corresponding video content must be displayed over the video.

More generally, the display of GUI over multimedia content is complicated when items are semi-transparently overlaid. Currently used techniques consist in compromises between graphics picture quality and GUI speed.

Furthermore, the currently known and used techniques to efficiently store and transmit large video content are based on non-conservative compression methods that reduce both the space required on storage and the picture quality. Generally, the quality is sufficient for a standard video content but the small static items, such as sub-titles, are indecipherable. Thus it is desirable to create and modify high-quality graphics and legible texts without editing the original movie.

Currently, interactivity is available over networks through hyperlinked web pages and client-server computer programs using techniques such as Java, ASP (Active Server Pages) and CGI (Common Gateway Interface). But the current state-of-art does not permit such interactivity over a video.

Problems associated with the currently used techniques include: (i) the difficulty to perform an independent and asynchronous rendering of animated semi-transparent overlays and digital video and, (ii) the need of a real-time processing for the achievement of a smooth video and low-latency GUI rendering.

### SUMMARY OF THE INVENTION

The present invention provides a system and method for receiving and displaying computer animations and graphical user interfaces, comprising interactive, animated, semi-transparent graphics and/or combined text or other displayable information. The animations are received from a data storage system or a network through a data stream, and possibly created, modified and destroyed either through the data stream or as a consequence of a user action on the interactive items. In addition, the animations are intended to be semi-transparently displayed over a background video content, consisting either in a single or in a set of digital video file(s) or stream(s). The invention provides a method of preserving video content quality and smoothness, and enabling reactive, high-quality, low-latency overlaid graphical user interfaces. Furthermore, the invention permits the addition of high-quality, animated, semi-transparent graphics and text enrichments to a video content without having to edit the overlaid graphics and re-animate the entire movie.

Video content is received as a data stream through a file or a network connection. Methods of encoding, transmitting, receiving and decoding video content is well within the scope of the ordinarily skilled person in the relevant art, and will not be discussed in detail herein. Similarly, the methods of creating, editing, encoding and transmitting interactive overlaid animations and/or graphical user interfaces to the system are well-known and will not be discussed in detail herein.

The system, which comprises a general purpose digital computer or equivalent apparatus, such as a PDA (Personal Digital Assistant), a set-top-box or a digital mobile phone, typically includes a display device such as a CRT (Cathode Ray Tube) screen or a flat panel whereon the video content and the overlaid interactive items are visibly displayed. The system further includes a display control device coupled to the display device, typically a central processing unit (CPU) of a type capable of running multimedia application software, the central processing unit further including a plurality of high capacity data storage memory devices and networks access, typically a CD-ROM disk drive or drives, a fixed hard drive or drives, random access memory (RAM), read only memory (ROM), modem and network adapter or adapters. The system also includes a mouse or other similar cursor control device. It may furthermore include multimedia equipment, typically an audio adapter, and a keyboard. Connection between these various well-known components of the system is well-known, and will not be discussed in detail herein.

The method includes the steps of (i) receiving and (ii) decoding a data stream containing the definition of the interactive animated graphics, (iii) merging them with the underlying video content, and (iv) displaying the resultant bitmap frame. The method farther includes steps of handling actions of the user on the graphical interface, resulting in (v) dynamically modifying the overlaid graphics and/or interface and (vi) performing actions on the underlying video. The method also includes the steps of enabling the communication between the overlaid graphical interface and a wide range of external components such as web pages, scripts (e.g. JavaScript or VBScript), and other custom computer programs. This communication includes: (vii) notification, to an external component, of an event (such as a user action on the graphical interface) and (viii) emulation and/or automated replication by an external component of a user action on the graphical interface, resulting in points (v) and (vi) as described above. The method further includes the steps of optimizing the rendering of overlaid items and merging them with video content to achieve real-time processing with smooth video replay and graphical user interface low-latency needs.

Other features of the invention will become apparent from the following detailed description considered in conjunction with the accompanying drawings. It is to be understood, however, that the drawings are designed solely for purposes of illustration, are not to scale, and are not to be used as a definition of the limits of the invention, for which reference should be made to the appended claims.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 shows an overall system of the embodiment in which the invention could reside;

FIG. 2 shows a flowchart establishing the relationships between functional blocks of the present invention;

FIG. 3 shows relationships between paradigmatic entities defined by the invention and handled by the method;

FIG. 4 shows the structure of the software system used by the method;

FIG. 5 shows a block-diagram depicting steps followed by the method in accordance with the present invention;

FIG. 6 shows exemplary data depicting the interactive overlays;

FIG. 7 shows exemplary interactive possibilities offered by the invention;

FIG. 8 shows optimizations applied to overlays and video rendering;

FIG. 9 shows optimizations applied to overlays merging with the video content.

### DETAILED DESCRIPTION OF THE PREFERRED EMBODIMENT

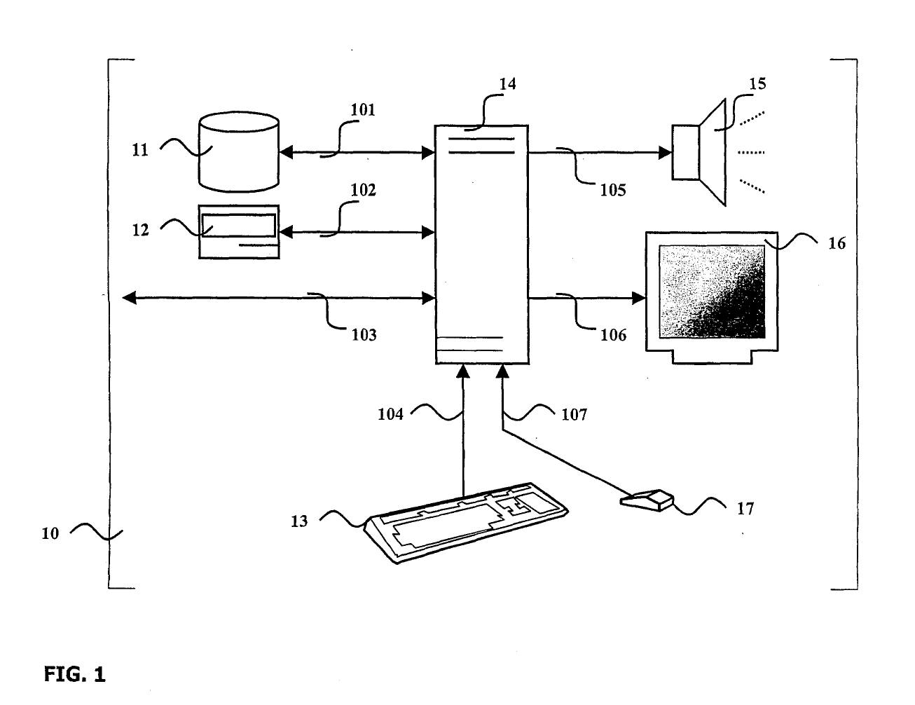

Turning first to FIG. 1, there is shown a system 10, which has in it, in one example, a central unit 14 containing a CPU and a memory. Connected to this central unit are a hard drive 11, a CD-ROM drive 12, multimedia equipment 15, a display 16, a keyboard 13 and a mouse 17. The central unit is also connected to a network through the connection 103. Displayed on the screen is a video background, loaded from the hard drive 11, the CD-ROM drive 12 or from distant equipment, e.g. a distant computer, through the network connection 103. Semi-transparent, animated, interactive items loaded from the hard drive 11, the CD-ROM drive 12 or from distant equipment, e.g. a distant computer, through the network connection 103 are displayed on top of the movie. Using the keyboard 13 and/or the mouse 17, the user can interact with the background video, or the overlaid content displayed on screen 16. In addition, the user can perform actions on any part of the system (input/output actions on devices 11, 12, 15, 16) and, over the network, on other devices using the principles of the presented invention.

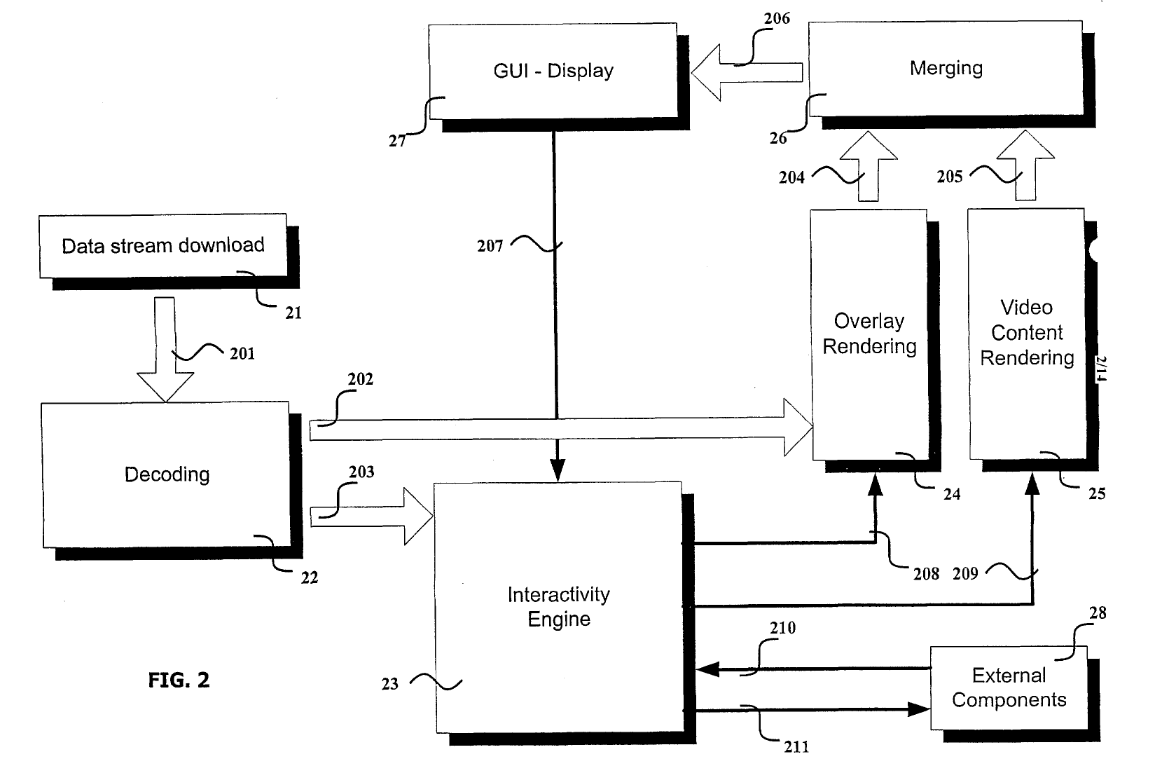

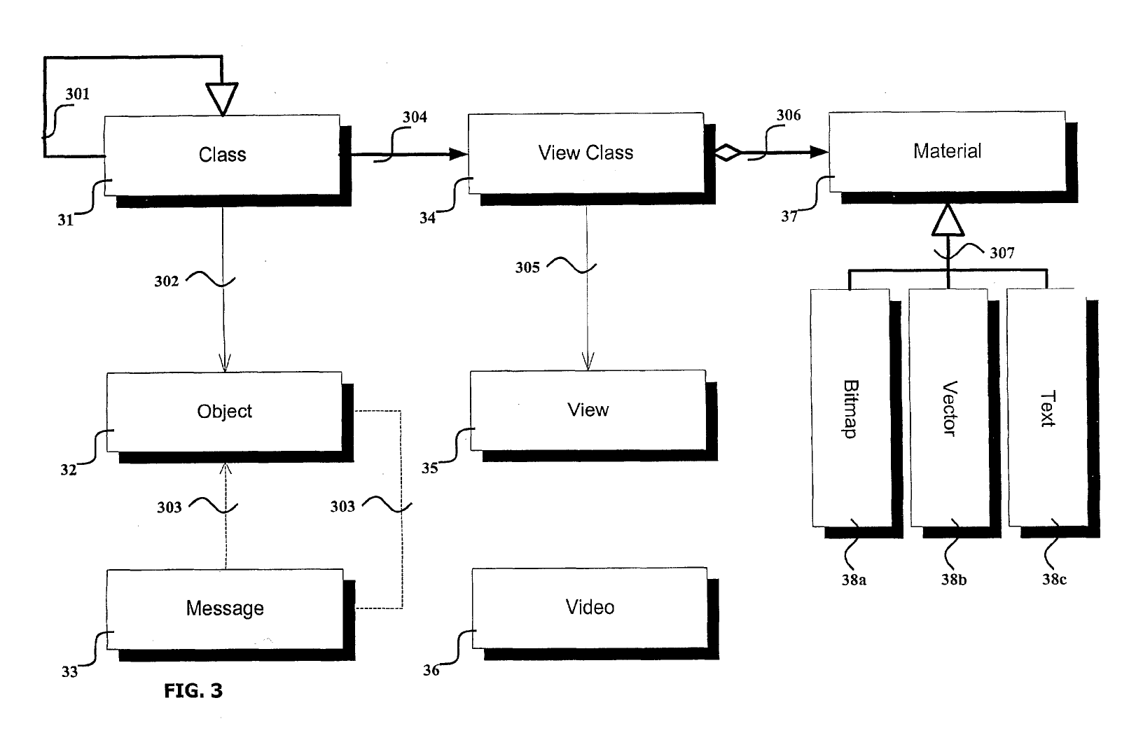

FIG. 2 shows in schematic form the data flows and control relationships the software of the system, according to the invention.

The method begins with the reception, by the receiver component 21, of the data stream containing the interactive overlays definition. This stream is deferred through the 201 data flow to a data decoder 22.

The decoder 22 decrypts and turns the data into a specific form called Actions. An action is a structured data container depicting the parameters of a given task. This task is then executed by the decoder 22 itself, and applies to either the overlay items processor 24 or the interactions manager 23. Tasks are symbolized on FIG. 2 as data flows, since the decoder 22 does not have a control responsibility on interactivity engine 23 and overlay manager 24.

As shown on FIG. 2, video content and graphics overlays are rendered independently (24, 25) and then merged by the specific component 26. The result is displayed on the screen (FIG. 1, 16).

If the displayed overlay includes of interactive items, the user can interact with them and act on the interactivity engine 23 through the link 207 so as to modify the behavior or appearance of overlays 24, video contents 25, external components 28, or even interactivity engine 23 itself, through the control links 208, 209, 210 and 211.

The Actions transmitted in the data stream and decoded by the decoder 22 are related to entities described by FIG. 3

The paradigmatic entities managed by the system are depicted in FIG. 3. The fundamental elements are the classes 31, the objects 32, which are instances of classes, the messages 33, enabling communication between objects, the view classes 34, that are categories of views 35, the materials 37 that represent the appearance of views, and the video content 36.

The relationships between all of these entities can include: inheritance between classes (301, 307), class-object link (302, 305) in which a class represents the scheme of many objects, reference (304), composition (306) and communication (303).

Each of these entities can be created, managed and destroyed through Actions defining the attributes, the parameters and the targets of tasks to be achieved. The definition of a class, particularly, contains the program pseudo-code executed when either events occurred or messages are received.

More generally, both an Action encoded in the data stream and the pseudo-code contained in a class definition can create, manage and destroy such entities. This, along with the fact that the streamed data can be received at any time, ensures that the interactive content can be modified at run-time. Thus, the method according to the invention permits dynamic graphical user interface updates, such as look-and-feel updates, features enhancements and news broadcasts.

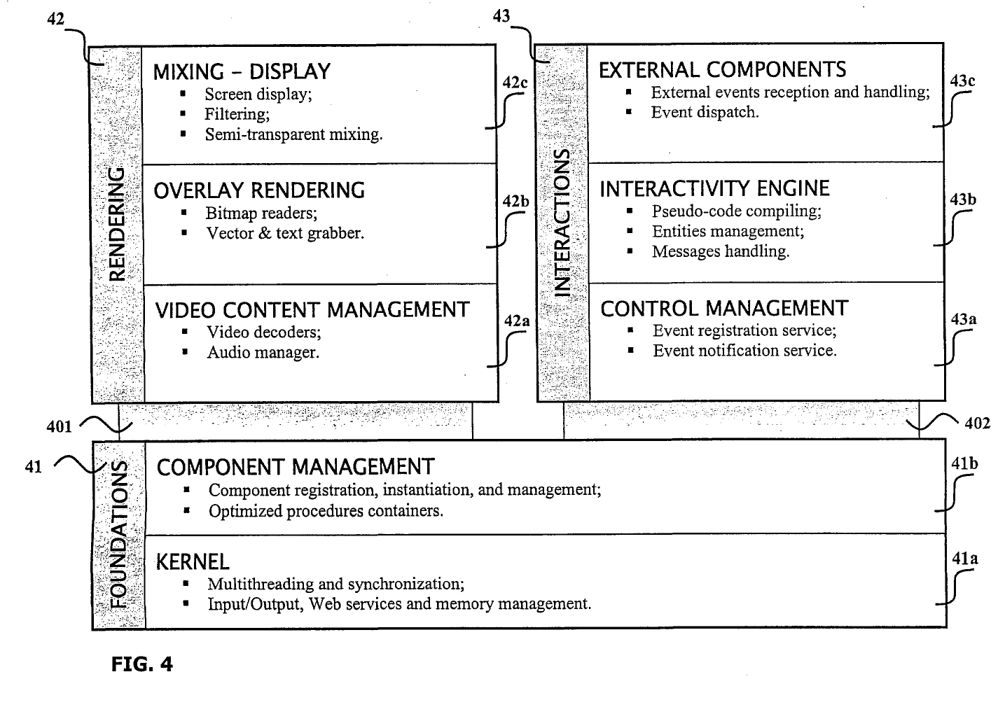

The method lies in both the system described in FIG. 1 and the software architecture shown on the FIG. 4.

As depicted in FIG. 4, the software components of the described method are divided into three parts, named Foundations (41), Rendering (42), and Interactions (43). Both the rendering and interactions (401, 402) rely on the foundations that offer low-level services to the higher-level parts. Each of them contains several components, each component in charge of specific tasks. The foundations 41 contains specific objects dedicated to base services (41a) such as input/output or memory management, and component management (41b). The rendering 42 contains components dedicated to audio/video background content decoding (42a), to animated, semi-transparent interactive overlays rendering (42b), and to filtering, mixing and display of overlaid video (42c). The interactions occurring either between the software components of the system or between internal and external components are managed by three groups of objects, respectively dedicated to control management (43a), interactivity management (43b), and external components communication (43c).

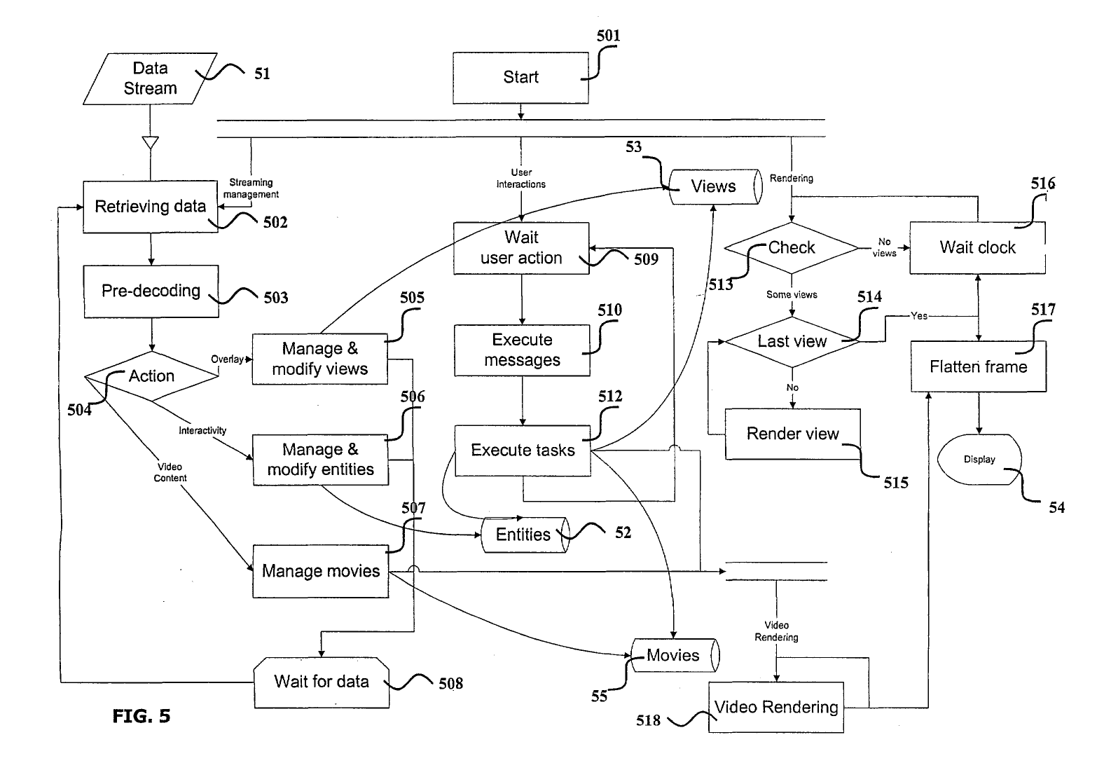

The block diagram of FIG. 5 illustrates how the system of the present invention implements the reception and decoding of the data stream, renders the overlays and video, and manages interactions in the system.

The procedure begins at step 501 with the software parts initialization. Three main tasks are started from the initialization 501: streaming management, user interactions and rendering.

The streaming management waits in state 502 for data 51 arrival. When this occurs, a pre-decoding 503 phase begins, continued by specific management tasks (505, 506, 507) dealing with overlays, movies or interactivity entities. These tasks may modify internal data storage (by creations, modifications and deletions), represented herein by storage 52, 53 and 55. The tasks 507 may also start a parallel task dealing with video rendering.

The streaming management process continues through 508 and 502 until and “end stream” action is received.

The rendering task manages (in local storage 53) and scans (513) a list of views. When this list is empty, a new scan is done after a short wait (whose duration is adjustable). As an optimization, any modification of the list marks it as ‘changed’, indicating the list needs to be checked. When the list contains views, each of them is rendered (515), and the resulting frame is flattened with the background content (517), and then displayed on the screen (54).

In parallel with the rendering task, the video decoding task is processed. This is done by the step 518 through calls to external systems. Once each frame is decompressed, it is flattened with the views (517), and the result is displayed on screen.

When the user is able to interact with the overlays, the user interactions task executes (510) the messages it received from the graphical user interface. Then it runs one or more tasks (512) that may, as does tasks 505, 506 and 507, modify the local storages 52, 53 and 55.

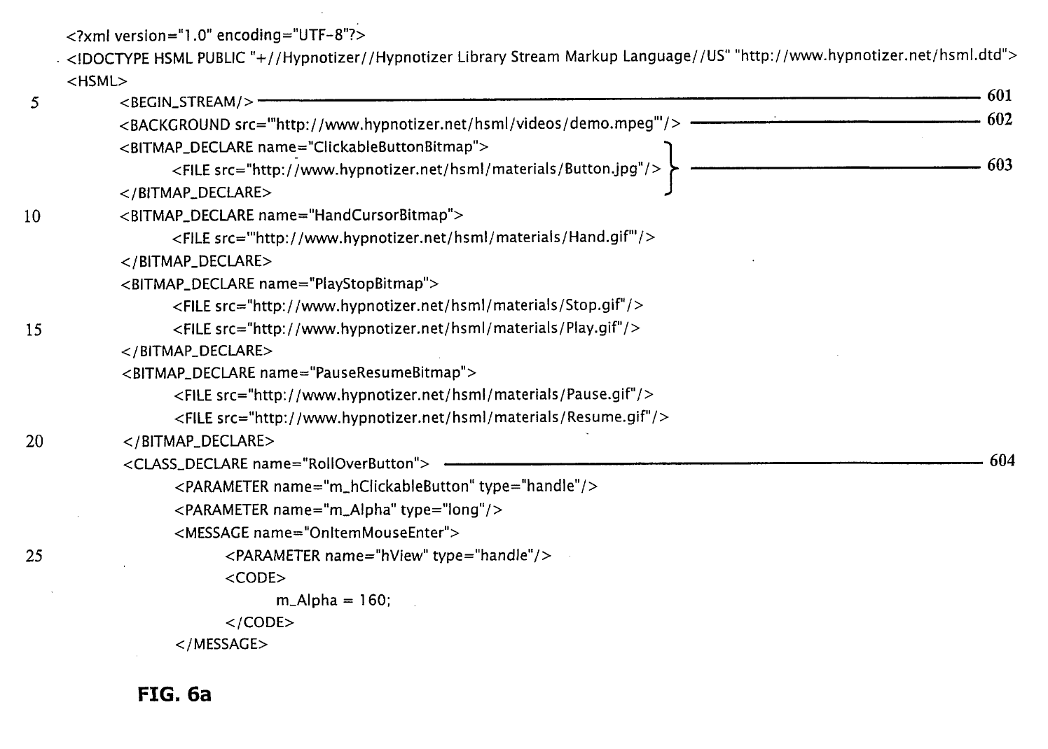

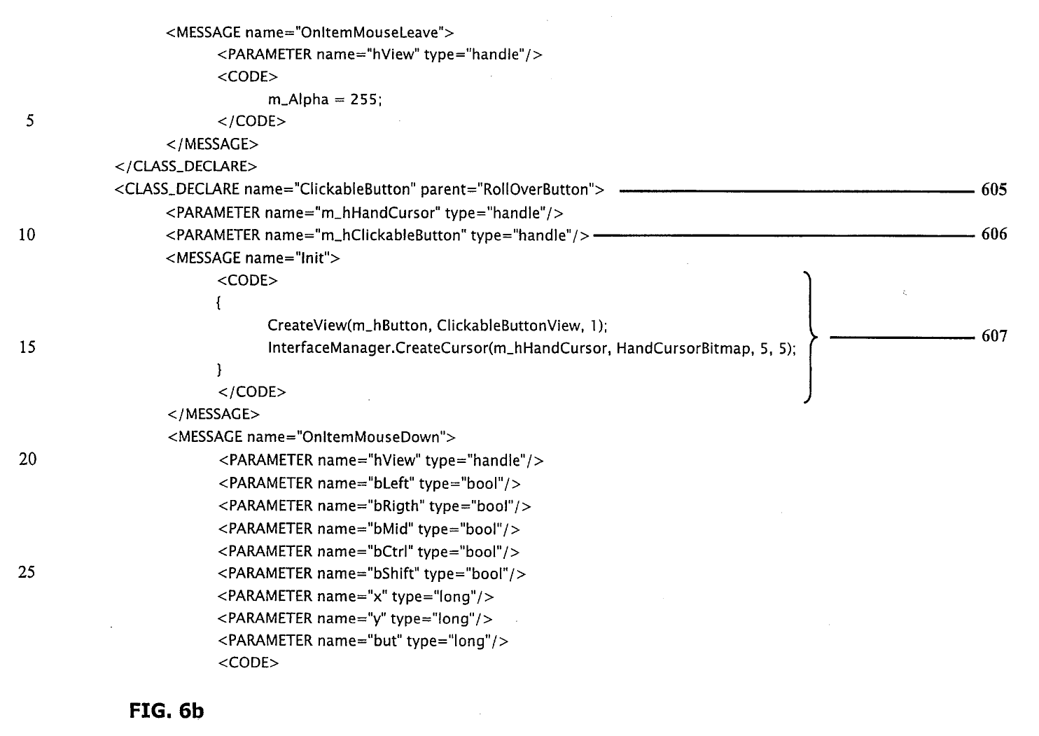

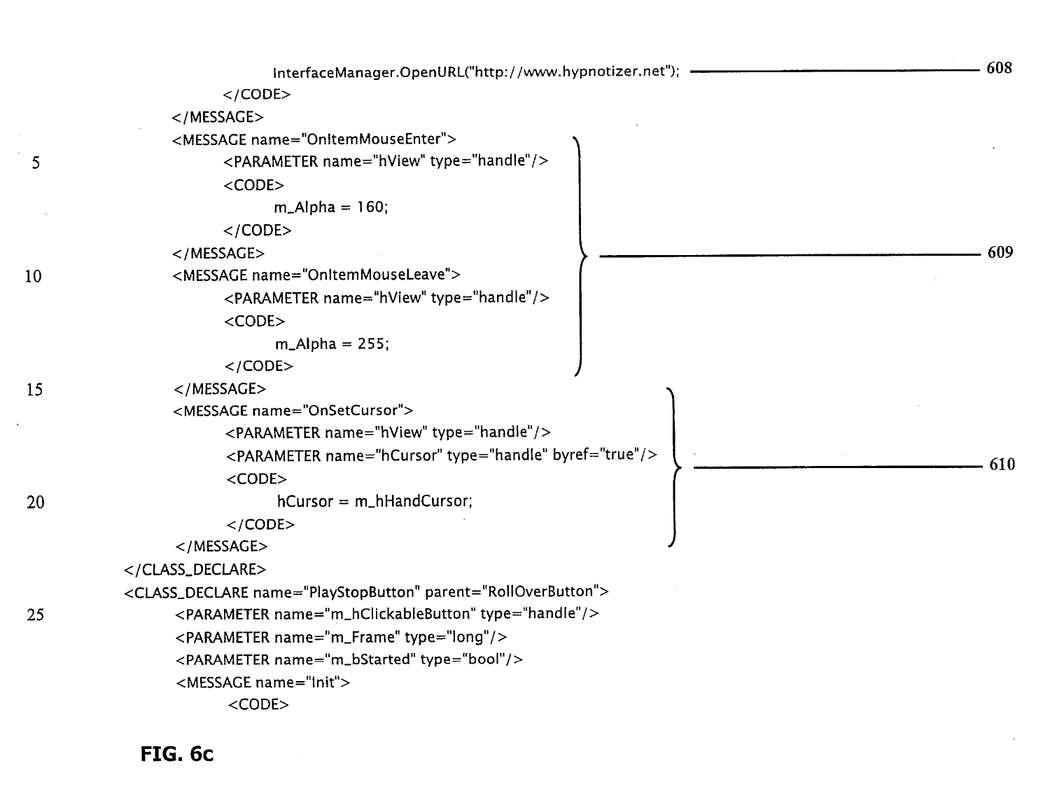

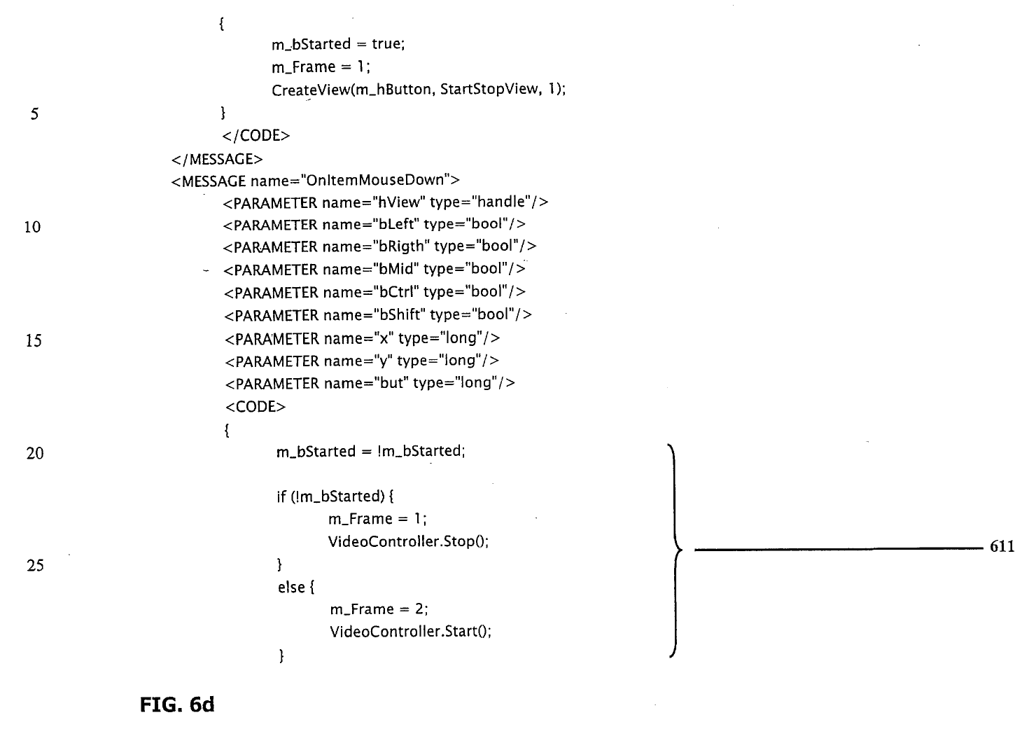

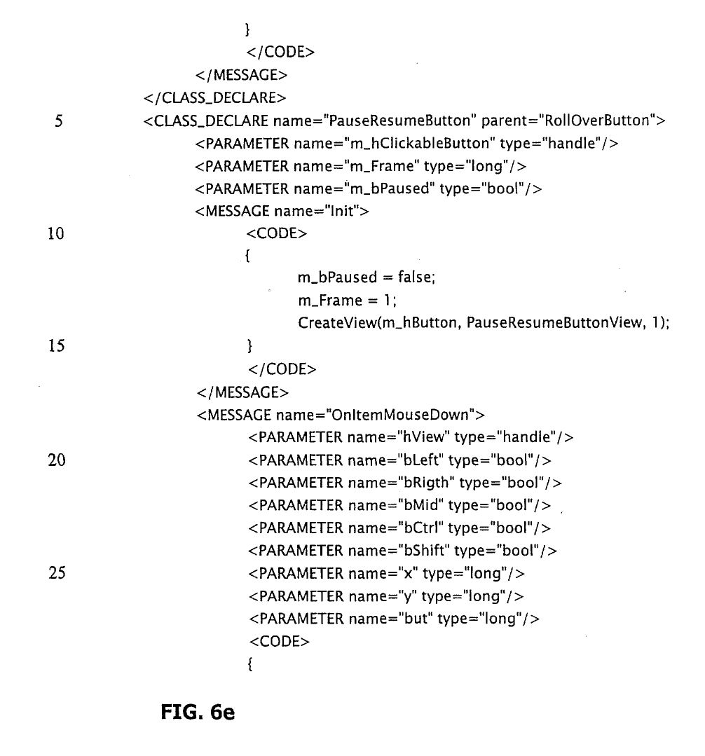

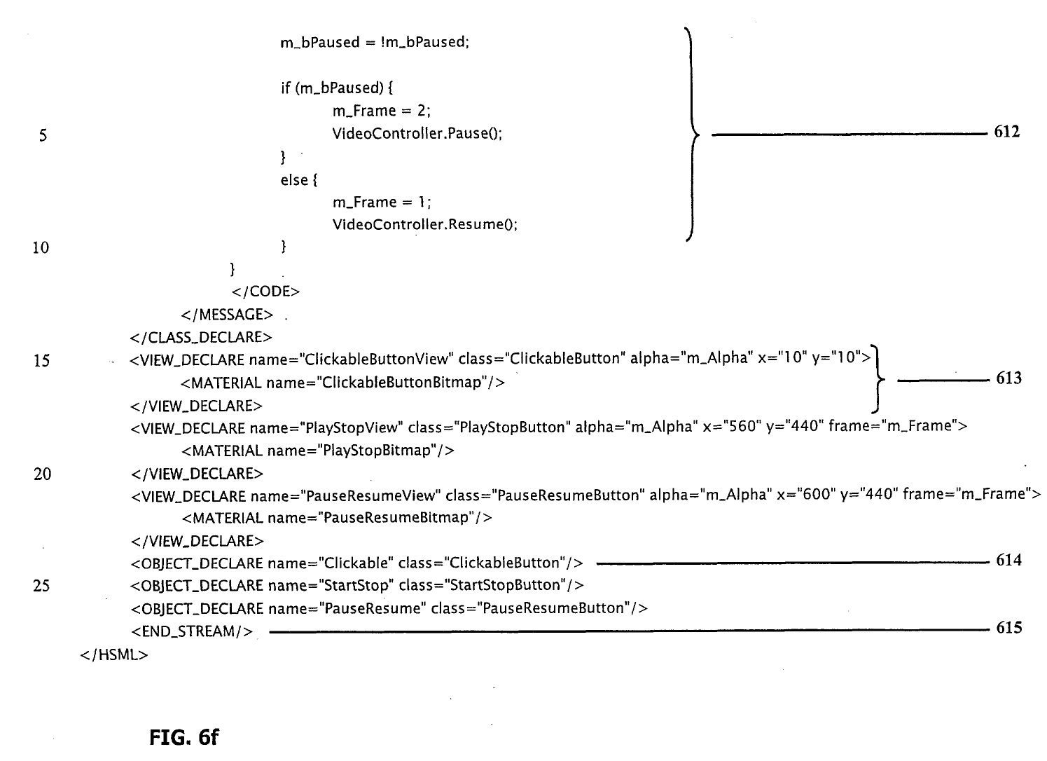

An example of an implementation of an embodiment of the present invention will now be provided with reference to FIGS. 6 through 9.

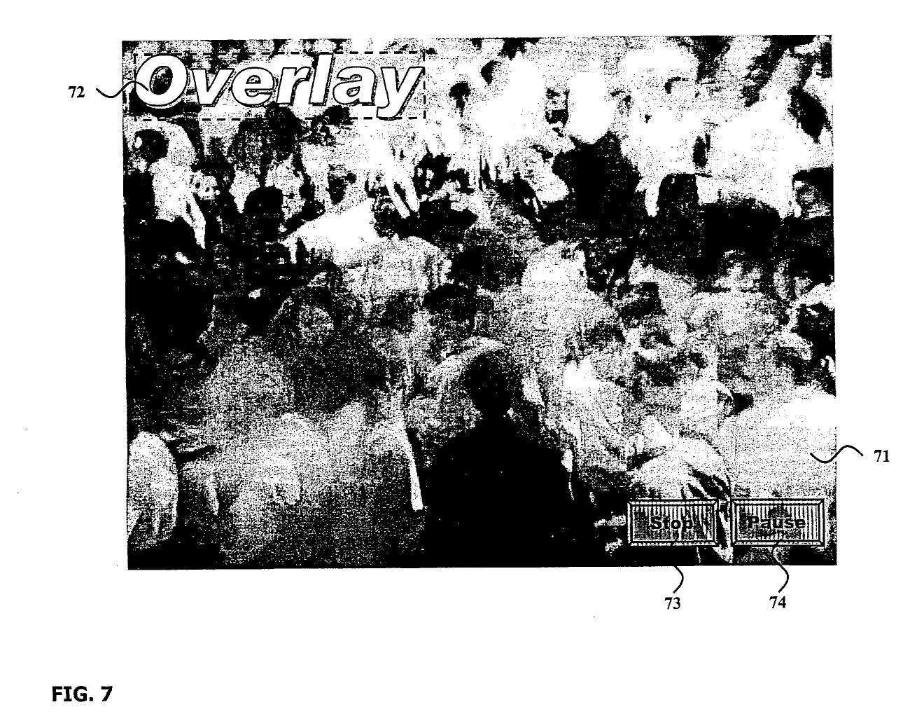

Interactive overlay content, as shown in FIG. 6, can be created by editing tools or generated by broadcast servers. The data shown in FIG. 6 demonstrates the way the described method can be used. The resulting overlays are drawn in FIG. 7. Note that the text shown in FIG. 6 represents only a readable form of the data stream, which in fact is compressed in order to be transmitted more rapidly.

As discussed above, a data stream, shown in the example of FIG. 6a-6f, is constituted of Actions. The first of the data stream must be a BEGIN_STREAM (601), and the last one an END_STREAM (615), both of them delimiting the overlay data stream. The BACKGROUND action (602) sets the background content, an MPEG movie in the present example.

Before declaring the objects representing the overlays, object classes and appearances are defined. In this example, the look-and-feel of overlays is represented by entities called materials, such as bitmapped graphics (603).

The next step is to declare the classes of objects. Here, the action 604 defines a general-purpose class (RollOverButton) having a button behavior, and other classes, such as action 605, inherit from it. A class can contain the definition of local variables (PARAMETER, 606) and methods and/or events (MESSAGE, 607). Behavior of a class is defined by the CODE enclosed in the MESSAGE blocks. Examples of such messages are handlers for mouse (OnItemMouseEnter, OnItemMouseLeave—609, OnSetCursor—610), keyboard and system events, or user-defined methods.

In the next step, previously defined materials are linked with a class. This is done through a VIEW_DECLARE action (613), which links the class with one or more materials. Multiple materials are considered as different frames representing the different states of a view. Views can be controlled through various properties, such as transparency level, X and Y position, frame number and more.

This link phase is completed at run-time by the creation of the view. In the present example, this is handled in the Init (607) system event handler, through calls to the CreateView method. This method can obviously be called everywhere else in a CODE definition.

The last step in an overlay definition is declaring the objects (614). Every object is named and belongs to a class, which defines its behavior.

FIG. 7 represents the results of the example data stream shown in FIG. 6. The BACKGROUND action (602) causes the decoding and drawing of movie 71. The definition of the ClickableButton class (605) along with the declaration of the Clickable object (614) cause the drawing of the interactive overlay 72. When the user clicks on the object 614, a web page is opened, as written in CODE (508). The buttons ‘Play/Stop’ (73) and ‘Pause/Resume’ (74) are defined in the same way using either PlayStopButton or PauseResumeButton classes and associated PlayStop or PauseResume objects. Both are buttons switching between two states (as shown in CODE 611 and 612).

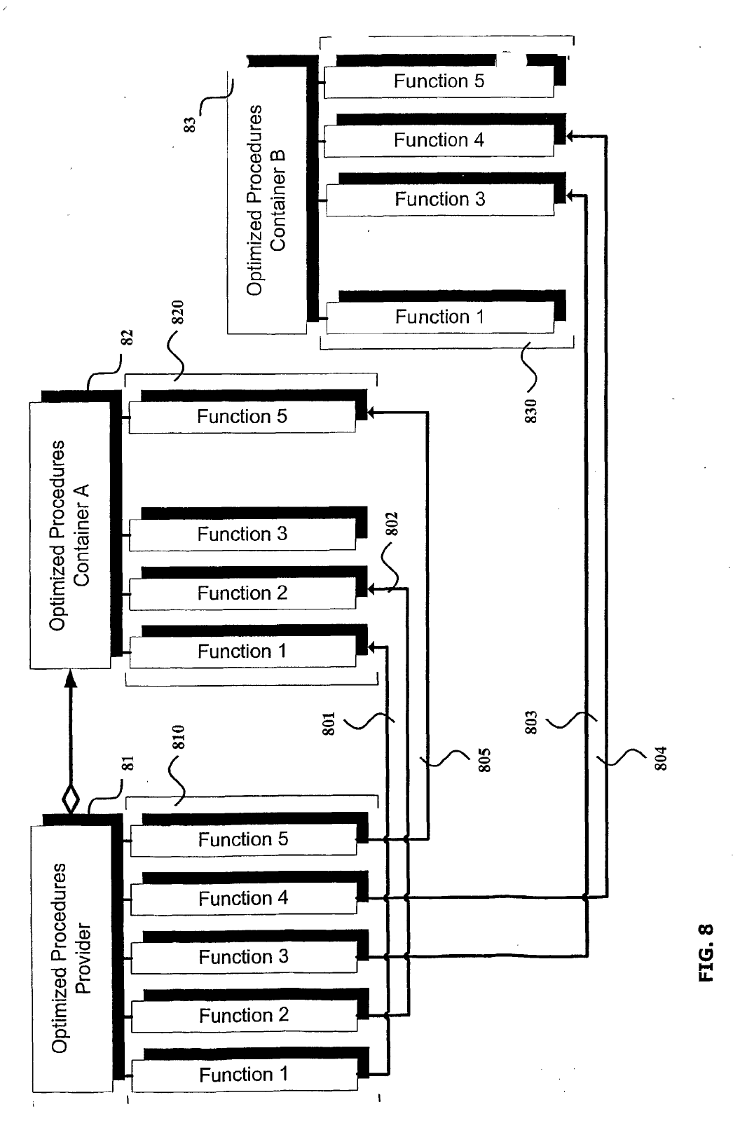

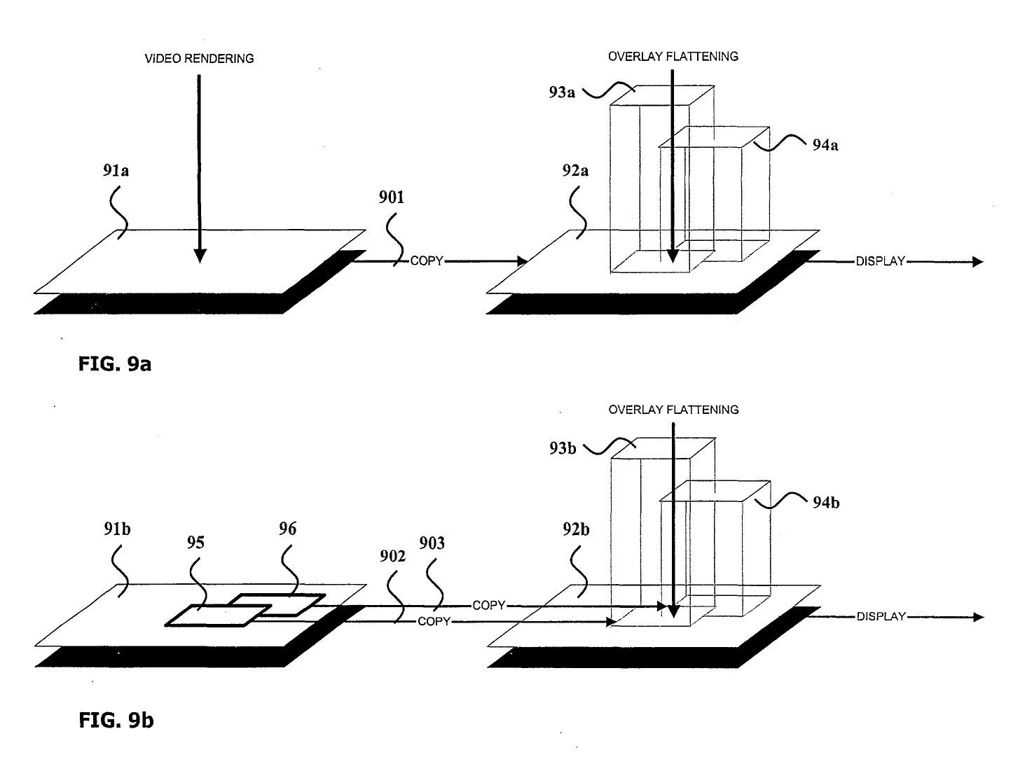

The preferred embodiments of the present invention include several additional improvements in order to optimize the rendering process. FIG. 8 and FIG. 9 describe improvements in the method, intended respectively to increase performances of overlays and video rendering (FIG. 5, steps 515 and 518) and frame flattening (FIG. 5, step 517).

As shown in FIG. 4, the Component Management (41) manages a small, extendable subset of objects dedicated to Optimized Procedures Containers (41b). Optimized procedures are time-critical functions that are grouped into specific containers. It is possible to define implementation of these procedures for each type of host computer (as described in FIG. 1). This optimization is especially intended for use of specific features of microprocessors (FIG. 1, item 14), such as MMX, SSE and 3DNow!™. FIG. 8 shows how Optimized Procedures Containers are handled by the present invention. This subsystem contains at least two components: an Optimized Procedures Provider (81) and one or more Optimized Procedures Container (82, 83). The containers are sorted by priority levels. This priority can be chosen, for example, in relation to the power of microprocessors addressed by containers. The provider defines a set of functions (810) that may be optimized. Each container can implement only a subset (820, 830) of these functions.

At run-time, during the initialization phase, the Optimized Procedures Provider loads the containers and requests each function. If the container implements a function, and if the computer meets the container requirements (in term of installed features), then the function (in fact, a pointer on it) is stored by the provider (801, 802, 805). In other cases, the provider tries every container in descending order, and the function used (803, 804) is guaranteed to be the best implementations for a given computer.

The second optimization relates to the frame-flattening phase of the method (FIG. 5, step 517). Typically, each time there is a change either in the background content or in the overlaid graphics, a complete redraw of the frame is needed. This can be improved by defining regions that can be validated (region changes have been applied), or invalidated (a redraw is needed since the region has changed). Therefore, the flattening region has the same size as the combination of invalidated overlaid items.

FIG. 9 compares both flattening methods. FIG. 9a represents the standard method, and FIG. 9b, the enhanced method

It is obvious that such an improvement does not apply to video refresh, since the entire frame needs to be redrawn. Consequently, the method exposed by FIG. 9b does apply only to redraw of overlay items between the background content updates. However, this sole case justifies enhancement of the method, since the flattening latency directly affects the graphical interface usability.

The flattening, as shown on FIG. 9a and FIG. 9b, is the second step of a more general mechanism. In fact, the rendering of a frame may begin with the video rendering. This updates the frame buffer (91a, 91b).

Since both rendering parts (video and overlays) are asynchronous, the very first step in the flattening process consists in duplicating the background content 91a, in order to keep a valid copy (92a, 92b) of the video frame buffer. During the second step, overlay items (93a, 93b, 94a, 94b) are rendered one after the other on the replica. Lastly, the resulting frame is sent to the display device.

The FIG. 9b improvement relies on the definition of regions covering the location of overlay items. For example, item 93b corresponds to region 95, and item 94b to region 96. A region (95) is invalidated when the matching overlay item has changed or moved. Moreover, when an overlay item has moved, two regions exist temporarily: a region related to the previous location of the overlay item and another matching the new location. During the first step of the process, only the invalidated regions are copied (902, 903) onto the buffer 92b. The second step remains unchanged.

It should also be understood that the preferred embodiment and examples described are for illustrative purposes only and are not to be construed as limiting the scope of the present invention, which is properly delineated only in the appended claims.

What is claimed is:

1. In a data processing apparatus having a graphics display device for displaying a display frame and having access to a local or non-local storage subsystem and/or having a network adapter to receive data streams, a method of receiving interactive dynamic overlays through a data stream and its displaying over a video content, the overlays consisting of interactive, animated, semi-transparent bitmapped graphics, vector graphics and/or combined text or other displayable information, and being intended to be semi-transparently displayed over a separately received background video content without having to edit and re-animate the entire content, said method comprising the steps of:
(a) Receiving the data stream from the local or distant storage subsystem;
(b) Decoding the received data and separating them in actions, which of them describing a task to be executed on the system, this tasks consisting in one of the following: creation, modification or deletion of an entity, definition or change of the background video content, and general stream management; entities being one of the following: class of objects, object, message, class of views, view or graphics material (appearance);
(c) Decoding the actions one after the other and executing the matching task, which can modify the content and state of interactivity engine, overlay rendering engine and/or video rendering engine;
(d) Rendering, in parallel, the views of overlay items;
(e) Rendering, in parallel, the background video movie;
(f) Flattening the views over the background video content, the overlays being semi-transparent;
(g) Handling, in parallel, the actions of user on interactive overlaid items;
(h) Executing tasks in response of user actions, as described in step (f); such tasks being programmed in the streamed class definitions, and being able to address the same entities as step (b), and the same targets as step (c).

2. The method of claim 1, wherein said steps (c) and (h) can handle messages from and/or send messages to external components, through interfaces that may be programmatically added to the described system.

3. The method of claim 1, wherein the performances of said steps (d) and (e) are enhanced by using computer-specific optimized functions.

4. The method of claim 1, wherein the performances of said step (f) is enhanced by using an optimized rendering method defining small regions, these regions being validated (i.e. updates being applied to the output buffer) or invalidated (i.e. updates being made in the region).

5. The method of claim 1, wherein the background video content consists of a limited or unlimited local or distant video stream, each type of video data being handled by a specific decoder, the method allowing new video decoders to be added to the system.

6. In a data processing apparatus having a graphics display device for displaying a display frame and having access to a local or non-local storage subsystem and/or having a network adapter to receive data streams, three engines dedicated to data stream decoding, interactivity management, overlay rendering management and video rendering management, the apparatus comprising:
(a) A data processing device;
(b) A display frame buffer connected to be accessed by the data processing device for storing pixels;
(c) One or more input devices, such as keyboard or mouse;
(d) Optionally, one or more local data storage(s) such as hard drive;
(e) Optionally, one or more network adapter(s);
(f) Optionally, a multimedia sound adapter;
(g) The data processing device being programmed to execute multiple tasks in parallel, each task running one of the four engines described above;
(h) The data stream decoder being programmed to receive, decode and analyze data stream in order to control any of the three other engines by causing creation, modification and deletion of entities managed by these engines;
(i) The interactivity engine being programmed to handle the computer's user actions on input devices, to turn them into messages and to execute tasks on overlay rendering or video rendering engines;
(j) The video rendering engine being programmed to manage and decode a video content, these content being controlled by either the interactivity engine or the data stream decoder;
(k) The overlay rendering engine being programmed to manage and render views, which are representations of interactivity engine entities, these views being interactive, animated and semi-transparent overlays, compound of one or more graphics materials standing for the various states of related entities, these overlays being drawn semi-transparently over the content rendered by the said video rendering engine (j).

7. The method of claim 6, wherein said engines (h) and (i) can handle messages from and/or send messages to external components, through interfaces that may be programmatically added to the described system.

8. The method of claim 6, wherein the performances of said engines (j) and (k) are enhanced by using computer-specific optimized functions.

9. The method of claim 6, wherein the performances of said engine (k) is enhanced by using an optimized rendering method defining small regions, these regions being validated (i.e. updates being applied to the output buffer) or invalidated (i.e. updates being made in the region).

10. The method of claim 6, wherein the said engine (j) manages a limited or unlimited local or distant video stream, each type of video data being handled by a specific decoder, the method allowing new video decoders to be added to the system.
